(19) United States
(12) Patent Application Publication
(10) Pub. No.: US 2025/0269562 A1
(43) Pub. Date: Aug. 28, 2025

(54) METHOD FOR RECYCLING POLYOLEFIN CONTAINERS

(71) Applicant: ALPLA WERKE ALWIN LEHNER GMBH & CO. KG, Hard (AT)

(72) Inventor: Bryan-Cody BORCHERS, Geilenkirchen (DE)

(21) Appl. No.: 18/858,179

(22) PCT Filed: Apr. 20, 2023
(86) PCT No.: PCT/EP2023/060311

§ 371 Date: Oct. 18, 2024

(30) Foreign Application Priority Data
Apr. 22, 2022 (CH) CH 00465/2022

(51) Int. Cl. B29B 17/02; B29B 17/04; B29K 23/00; B29K 67/00; B29L 31/00

(52) U.S. Cl. CPC B29B 17/02; B29B 2017/0203; B29B 2017/0279; B29B 2017/0289; B29B 17/0412; B29B 2017/046; B29K 2023/065; B29K 2067/003; B29L 2031/712

(57) ABSTRACT

A method for recycling polyester containers, in particular PET containers, said method including the following method steps: sorting the containers, comminuting the containers to produce flakes, friction washing the flakes, sorting the flakes, and extruding and granulating the cleaned flakes. The flake-sorting process is used to separate flakes which have a foreign polymer that is different from the polyester, and the flake-sorting process is a combination of a color-sorting process, a screening step, and an optical polymer-sorting process.

### FIELD OF THE INVENTION

The invention relates to a method for recycling polyolefin containers in accordance with the preamble of claim 1.

### PRIOR ART

The recycling of containers made of polyolefins is of great importance for the use of existing resources as a large number of containers are made of HDPE (high-density polyethylene) in particular. In this respect, recycling HDPE containers after disposal is of great importance and a particularly efficient recycling process offers great cost-saving potential.

HDPE recycling streams contain PP (polypropylene) because caps and other closures are made of PP and are disposed of together with the containers. In accordance with planned EU disposal regulations, the PP caps/closures will have to be disposed of with these in the future. The caps are mostly made of injection-molded PP. An HDPE recycling stream typically contains between 3 to 15 wt. % PP, which is derived from caps and also from misplaced waste, such as PP bottles. However, only pure HDPE is valuable for the processing industry. Therefore, the PP must be separated from the HDPE as completely as possible.

Since HDPE and PP have similar densities, separation processes that exploit the different densities of the plastics to be separated (float-sink separations in water, hydrocyclones, air sifters, etc.) are not very efficient. That is why near-infrared container and flake sorters are used in accordance with the prior art. Flake sorting according to different colors is also used. Such sensor-based sorting devices are expensive to purchase and can only process a limited volume flow. Therefore, at least two expensive analysis machines must be used to achieve the necessary volume throughput of an exemplary system of approximately 3 mt/h. In addition to separating the unwanted PP from caps, closures and misplaced bottles from the HDPE, near-infrared (NIR) flake sorting also aims to enrich these contaminants in a so-called reject stream.

### OBJECT OF THE INVENTION

The disadvantages of the described prior art result in the object of improving the method for recycling polyolefin containers (in particular HDPE containers) in such a way that the sorting or depletion of PP in the recycling stream can be carried out with reduced machine capacity and is therefore cost optimized. However, an rHDPE quality is still generated from the NIR-sorted flakes which can be reliably used again in container applications.

### DESCRIPTION

The stated object is achieved with a method for recycling polyolefin containers, in particular HDPE containers, by the features listed in the characterizing section of claim 1. Developments and/or advantageous alternative embodiments form the subject-matter of the dependent claims.

The invention is preferably characterized in that the flake-sorting process d is used to separate PP flakes and the flake-sorting process d is a combination of a color-sorting process d1, a screening step d2, and a polymer-sorting process d3. This triple combination for sorting out PP flakes allows PP flakes in particular to be sorted out from the screened fraction in which the PP flakes accumulate because they are more brittle than polyolefin flakes. This means that only a screened fraction has to undergo optical polymer sorting and not the entire recycling stream.

In a particularly preferred embodiment of the invention, a first and a second screened fraction of flakes is created in the screening step. Since PP is more brittle than HDPE, the PP flakes are more heavily comminuted than the HDPE flakes during friction washing c. As a result, the washed PP flakes accumulate in the range <4-6 mm and in particular in the range <3-4 mm. Therefore, a separate, fine screened fraction is created for this fine range. There are so few PP flakes in the second coarse screened fraction that this fraction does not need to be optically sorted and the PP flake concentration does not need to be depleted. The flow rate of the first screened fraction does not exceed the sorting capacity of a single near-infrared or laser sorting system. The capacity of the required polymer sorting technology can be reduced by 50-60% by forming the two screened fractions. This means that a second optical sorting system to sort the flow rate of the entire recycling stream is no longer necessary. The investment costs and machine space requirements can be significantly reduced by the reduced machine capacity and at the same time the depletion quality of the PP is unchanged or even improved compared to sorting the entire recycling stream. The first screened fraction is 40-50 wt. % and the second screened fraction is 50-60%.

It is preferred if the first screened fraction has flakes with a grain size <x mm and the second screened fraction has flakes with a grain size >x mm. This makes it possible to have only one flake stream, which has a critical PP-contaminated proportion and needs to be depleted.

The limit grain size is expediently x=6 mm, preferably 5=mm and particularly preferably x=4 mm. By choosing the limit grain size or the screen cut, a second screened fraction is reliably obtained in which no purification step by removing PP flakes is necessary. The largest proportion of PP flakes is found in the first screened fraction, which is efficiently freed of PP flakes, for example, by a near-infrared or laser sorting system. As a result, the first screened fraction is freed of PP flakes to such an extent that it can be mixed again with the second screened fraction and rHDPE granulate can be produced which has the quality to be used again to manufacture containers.

It has proven to be useful if the polymer-sorting process d3 is carried out directly after the screening step d2. This allows the first screened fraction to be immediately freed of PP contamination before further method steps are carried out.

It has been found to be useful to separate PP from the second screened fraction by a further optical polymer-sorting process d4 and to carry out the further polymer-sorting process d4 directly after the screening step d2. This further improves the purity of the entire recycling stream. This is particularly useful when PP contents are atypical in this grain range. The prior screening at least allows a more targeted adjustment of the NIR sorting machine parameters in d3 and d4 in order to achieve a more reliable separation.

In a further embodiment of the invention, a third screened fraction with a grain size <1 mm is created in the screening step and the first screened fraction therefore has a grain size between 1 mm and x mm. This means that the finest screened fraction, which primarily contains PP flakes and has no value for the recycling stream for the production of rHDPE, can be used directly in other recycling processes (chemical recycling, rPP recycling or recycling for PE/PP mixed applications).

It is advisable to carry out the color-sorting process d1 before the screening step d2. Optical color sorting has higher resolution rates and can therefore be used more flexibly. In the case of contamination in all grain classes, the material flow can be color-sorted in advance to simplify the process technology/reduce the number of machines.

In accordance with a further embodiment of the invention, it is also conceivable that the color-sorting process d1 takes place after the polymer-sorting process d3. This arrangement is particularly useful when a grain class is disposed of directly and color contaminants arise in this specific grain class.

It is advantageous if the color-sorting process d1 takes place after the mixing of the first and second screened fractions. This allows the color-sorting process d1 to be carried out as the final step of the flake-sorting process d, before the flakes are extruded or temporarily stored before extrusion. This allows the color-sorting process d1 to be carried out as the final step of the flake-sorting process d, before the flakes are extruded or temporarily stored before extrusion.

The invention is also preferably characterized in that the first and second screened fractions are sorted separately in a first and a second color-sorting process d11, d12. This has the advantage that the first and second color-sorting processes d11 and d12 can be carried out particularly accurately, since two screened fractions are color-sorted separately. Accordingly, it is also possible to adapt the parameter selection of the first and second color-sorting processes to the respective flake sizes of the first and second screened fractions and thus optimize the color recognition.

In a further preferred embodiment of the invention, the cleaned flakes of the first and second screened fractions are stored in a flake storage facility f in a defined ratio. This means that the flake composition required to produce the rHDPE pellets can be stored and fed to the extrusion process e at any time.

In a further preferred embodiment of the invention, the cleaned flakes of the first and second screened fractions are partially stored temporarily in a first and a second intermediate storage facility g1, g2 and the temporarily stored flakes are fed to the flake storage facility f in a defined ratio. The first and second screened fractions can therefore be stored separately before being mixed. It is also conceivable that the flakes of the first and second screened fractions are not mixed and are processed separately.

In a further particularly preferred embodiment of the invention, the third screened fraction is disposed of h. The term disposal should also include other types of recycling (chemical recycling, rPP recycling or recycling for PE/PP mixed applications). In this third fine screened fraction with flakes smaller than 1 mm (HDPE fines/HDPE dust), the PP content is particularly high and up to 8-10 times higher than in the other screened fractions. This is because, as already explained above, PP is more brittle than HDPE and is heavily comminuted during friction washing. The disposal of the third screened fraction therefore also contributes to obtaining a recycling stream that is as clean as possible.

Further advantages and features will become apparent from the following description of three exemplary embodiments of the invention with reference to the schematic drawings. In the figures, in a representation that is not to scale:

Further advantages and features will become apparent from the following description of four exemplary embodiments of the invention with reference to the schematic drawings. In the figures, in a representation that is not to scale:

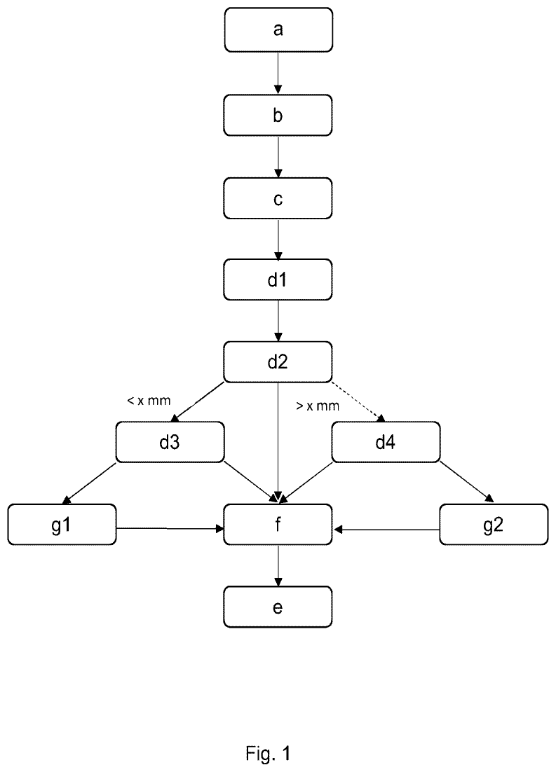

FIG. 1: is a first flow diagram showing a first embodiment of a method for recycling polyolefin containers;

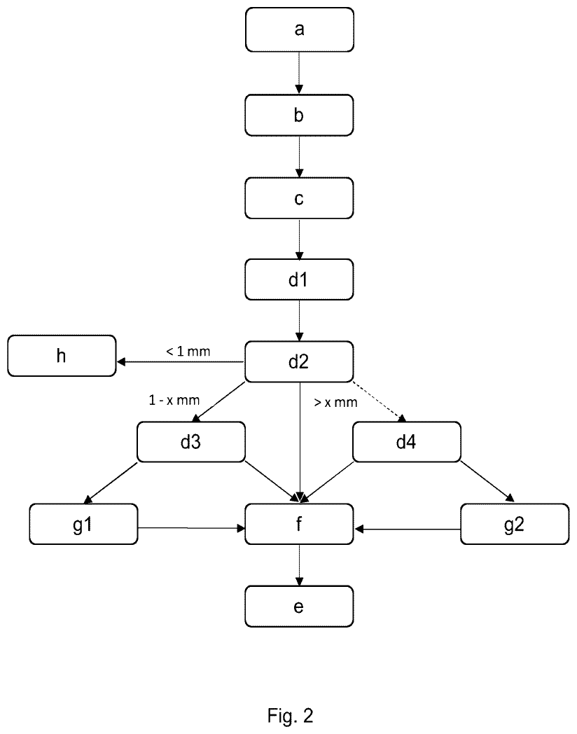

FIG. 2: is a second flow diagram showing a second embodiment of the method, in which three screened fractions are produced instead of two;

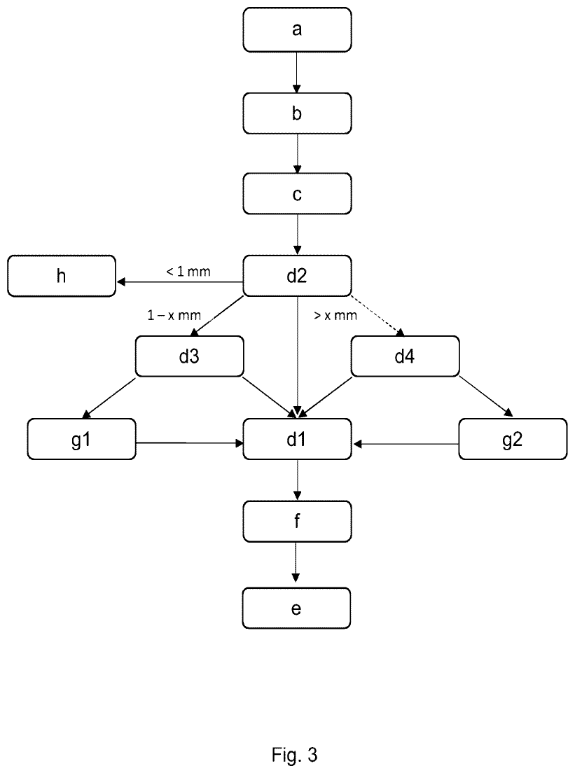

FIG. 3: is a third flow diagram showing a third embodiment of the method for recycling polyolefin containers; and

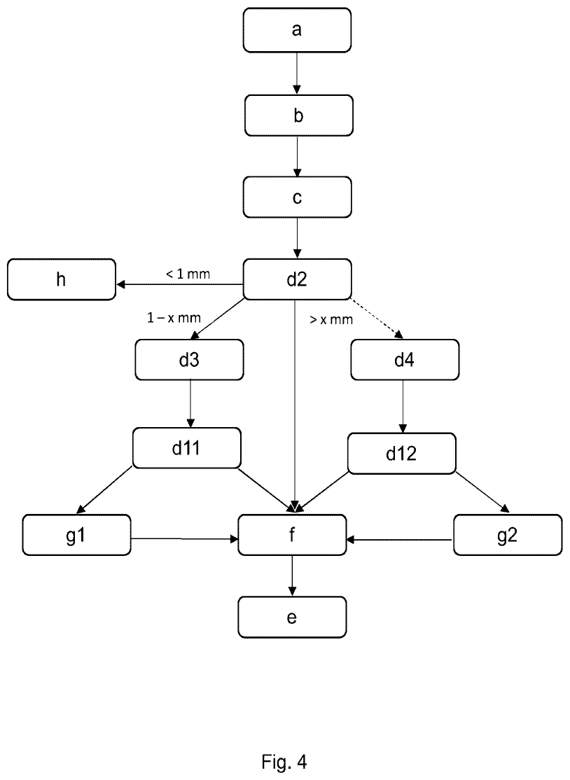

FIG. 4: is a fourth flow diagram showing a fourth embodiment of the method for recycling polyolefin containers.

FIGS. 1 to 4 show four embodiments of an improved method for recycling polyolefin containers. HDPE containers represent the largest proportion for the application of this method, although the method is also suitable for containers made of other polyolefins. Method steps a to c are basically known. In step a, the HDPE containers sent for recycling are sorted. This is done using color-sorting and near-infrared (NIR) technologies. Before the bottles are sorted, a step for removing metals and labels may also be provided. The HDPE containers can also be pre-cleaned. In step b, the HDPE containers are comminuted into flakes, in particular ground in a mill. In step c, the flakes are washed in a friction wash.

Typical flake sizes for HDPE after the mill are in the target range of 4-15 mm, depending on the mill used. However, during the washing process c, a high level of friction is generated between the flakes, causing the flakes to break down into finer particles. It is noticeable that polypropylene (PP) in particular is very brittle and accumulates strongly in the range <4-6 mm and in particular in the range <3-4 mm. The PP enters the recycling stream primarily through caps or closures on HDPE containers. The incoming recycling stream can therefore contain between 3-15 wt. % PP. When PP is injection molded, it is particularly brittle. Therefore, as described below, the flakes are screened to obtain different screened fractions. The majority of PP flakes are present in the screened fraction, which contains flakes which are smaller than the limit grain size. In principle, the degree of PP depletion using optical polymer sorting (near-infrared, laser) in accordance with the prior art is sufficient to obtain recycled HDPE flakes with good purity and quality. However, optical polymer sorting represents a bottleneck in the continuous stream because the required flow rate is much greater than the amount that a polymer sorter can process. Therefore, the recycling stream must be divided and passed through at least two sorters. This causes high investment costs and at least doubles the space required for the sorting system.

The flake-sorting process d is carried out in a combination of multiple separation steps of the flakes, namely a color-sorting process d1, a sieving or screening step d2 and a polymer-sorting process d3.

Color sorting d1 is usually carried out using color cameras, sometimes in combination with near-infrared (NIR), and usually takes place in a specially designed sorting system. Color sorting d1 sorts out flakes that could affect the desired color of the containers made from the recycled granulate.

The ground, (hot) washed & color-sorted flakes are split up into their size composition using a machine-driven screen or two screens in the screening step d2 in order to be able to apply the best possible further treatment for all flake sizes. The initial fraction is divided into a first, second and an optional third fraction:
1. <x mm or 1-x mm if a third screened fraction is present
2. >x mm
3. <1 mm
   wherein the limit grain size is x 6 mm, preferably 5 mm, particularly preferably 4 mm.

By creating a first and second screened fraction, the smaller PP flakes are enriched in the first screened fraction. In the second screened fraction, the proportion of PP flakes is so low that they do not need to be removed from the second screened fraction by means of optical polymer sorting. The small volume flow of the first screened fraction can be freed from the PP flakes using an optical polymer sorter without the polymer sorter reaching its capacity limits. A single polymer sorter is therefore sufficient to sort out sufficient PP flakes from the entire HDPE recycling stream. This allows significant savings in terms of sorting costs, on the one hand because the number of machines can be reduced and on the other hand because a sorting machine requires less space.

The second fraction >x mm is separated and optionally further purified by optical sorting systems using near-infrared or laser sources. A further optical polymer-sorting process d4 is optionally provided in the flow diagrams of FIGS. 1 to 4 and shown by the dashed arrow. The second screened fraction d2 can therefore be conveyed directly into the flake storage facility f or is fed to the further polymer-sorting process d4. Depending on the origin, PP depletion in the second screened fraction is no longer necessary to produce bottle-grade rHDPE.

Depending on the origin of the material, the third screened fraction <1 mm can be considered a side stream for other recycling and disposed of h accordingly (option in FIGS. 2-4). The third screened fraction is therefore not taken into account for the further process.

Before extrusion e, the flakes must have passed through at least the flake-sorting stages d1, d2 and d3 to ensure maximum removal of PP from the first screened fraction.

The following analyses can be used to determine contamination, in particular PP:
Differential scanning calorimetry (DSC) in accordance with DIN EN ISO 11357 (in preparation for the measurement, pellets or test specimens must be created from the material provided)
Infrared spectroscopy (NIR/FTIR) (in preparation for the measurement, pellets or test specimens must be created from the material provided)
Infrared spectroscopy (NIR/FTIR) alternatively on flake quantities

The different polymer components in HDPE can be detected using DSC and NIR/FTIR. The contamination level depends very much on the material origin and process genesis. Typical contamination levels on the market are as follows:

Without advanced screening:
rHDPE white, rHDPE natural, each pre-sorted at bottle level, color flake-sorted, without polymer sorting: PP-% in accordance with DSC <1.5%
rHDPE gray (ESP) each pre-sorted at bottle level, color flake-sorted, without polymer sorting: PP-% in accordance with DSC >3%
rHDPE gray (ESP) each pre-sorted at bottle level, color flake-sorted, including polymer sorting: PP-% in accordance with DSC <1.5%

Use of advanced screening:
>4 mm: rHDPE gray (ESP) pre-sorted at bottle level, color flake-sorted, without polymer sorting: PP-% in accordance with DSC <1.5%.
>6 mm: rHDPE gray (ESP) pre-sorted at bottle level, color flake-sorted, without polymer sorting: PP-% in accordance with DSC <1.5%.
<4 mm: rHDPE gray (ESP) pre-sorted at bottle level, color flake-sorted, without polymer sorting: PP-% in accordance with DSC >3%.
<6 mm: rHDPE gray (ESP) pre-sorted at bottle level, color flake-sorted, without polymer sorting: PP-% in accordance with DSC >3%

The target value of PP in rHDPE is <1-1.5% PP in accordance with DSC.

With the present method comprising a color-sorting process d1, a screening step d2 and an optical polymer-sorting process, the required capacity for polymer flake-sorting technology is reduced by 50-60% by focusing the polymer flake sorting on critically PP-contaminated material stream components (first screened fraction).

As can be seen from FIGS. 1 to 4, the polymer-sorting process d3 or d4 takes place directly after the screening step d2. In accordance with the first exemplary embodiment, as shown in FIG. 1, the color-sorting process d1 takes place before the screening step d2. The color-sorting process d1 can also take place after the polymer-sorting process d3, d4 (FIG. 3). The color-sorting process d1 can take place after the mixing of the first and second screened fractions (FIG. 3, 3rd exemplary embodiment) or the first and second screened fractions are each subjected to a first and second color-sorting process (d11, d12) before they are mixed (FIG. 4, 4^{th} exemplary embodiment).

The first and second fractions can be stored in a defined mixing ratio in a flake storage facility f and retrieved for extrusion e into pellets in the predetermined mixing ratio. To establish the mixing ratio, the flake storage facility f is filled with defined mass flows of the first and second screened fractions.

The cleaned flakes of the first and second screened fractions can be temporarily stored in a first and a second intermediate storage facility (g1, g2) by diverting side streams. The temporarily stored flakes are fed to the flake storage facility f in a defined ratio. This means that the first and second screened fractions can also be stored separately from each other.

Examples of ratios of the screened fractions in wt. % are given in the three tables below depending on the limit grain size or screen cut x:

TABLE 1
Distribution of flakes in the three screened fractions before sorting

| | Proportion before sorting | | |
|---|---|---|---|
| Screen cut at x mm | <1 mm | 1 − x mm | >x mm |
| x = 4 mm | 1.0% | 30% | 69% |
| x = 5 mm | 1.0% | 40% | 59% |
| x = 6 mm | 1.0% | 50% | 49% |

TABLE 2
Sorting losses of the flakes in the three screened fractions

| | Sorting losses (relative to the | | |
|---|---|---|---|
| | respective fraction) | | |
| Screen cut at x mm | <1 mm | 1 − x mm | >x mm |
| x = 4 mm | 100% | 4.5% | 2.0% |
| x = 5 mm | 100% | 4.0% | 1.8% |
| x = 6 mm | 100% | 3.0% | 1.5% |

TABLE 3
Distribution of flakes in the three screened fractions after sorting

| | Final flake proportion | | |
|---|---|---|---|
| Screen cut at x mm | <1 mm | 1 − x mm | >x mm |
| x = 4 mm | 0% | 29.8% | 70.2% |
| x = 5 mm | 0% | 39.9% | 60.2% |
| x = 6 mm | 0% | 50.4% | 50.1% |

### LIST OF REFERENCE SIGNS

a Container sorting
b Comminuting the containers to produce flakes
C Friction washing the flakes
d Flake sorting
d1 Color sorting
d11 First color sorting
d12 Second color sorting
d2 Screening step
d3 Polymer sorting of the second screened fraction
d4 Polymer sorting of the third screened fraction
e Extrusion
f Flake storage facility
g1 First intermediate storage facility
g2 Second intermediate storage facility
h Disposal

1.-13. (canceled)

14. A method for recycling polyolefin containers, in particular HDPE containers, said method comprising the following method steps:
sorting the containers,
comminuting the containers to produce flakes,
friction washing the flakes,
sorting the flakes,
extruding and granulating the cleaned flakes,
wherein
the flake-sorting process is used to separate flakes and the flake-sorting process is a combination of:
a color-sorting process,
a screening step, and
an optical polymer-sorting process.

15. The method in accordance with claim 14, wherein in the screening step at least a first and a second screened fraction of flakes are produced.

16. The method in accordance with claim 15, wherein the first screened fraction comprises flakes with a grain size <x mm and the second screened fraction comprises flakes with a grain size >x mm.

17. The method in accordance with claim 14, wherein the limit grain size is x=6 mm.

18. The method in accordance with claim 15, wherein PP is sorted out from the first screened fraction by the optical polymer-sorting process and the polymer-sorting process takes place directly after the screening step.

19. The method in accordance with claim 15, wherein PP is sorted out from the second screened fraction by a further optical polymer-sorting process and the further polymer-sorting process takes place directly after the screening step.

20. The method in accordance with claim 15, wherein in the screening step a third screened fraction with a grain size <1 mm is created and thereby the first screened fraction has a grain size between 1 mm and x mm.

21. The method in accordance with claim 14, wherein the color-sorting process takes place before the screening step.

22. The method in accordance with claim 15, wherein the color-sorting process takes place after the mixing of the first and second screened fractions.

23. The method in accordance with claim 15, wherein the first and second screened fractions are sorted separately in a first and a second color-sorting process.

24. The method in accordance with claim 15, wherein the cleaned flakes of the first and second screened fractions are stored in a flake storage facility in a defined ratio.

25. The method in accordance with claim 24, wherein the cleaned flakes of the first and second screened fractions are partially stored temporarily in a first and a second intermediate storage facility and the temporarily stored flakes are fed to the flake storage facility in a defined ratio.

26. The method in accordance with claim 20, wherein the third screened fraction is fed to a disposal facility.
